(19) United States
(12) Patent Application Publication
(10) Pub. No.: US 2021/0031191 A1
(43) Pub. Date: Feb. 4, 2021

(54) Smart Microplates and Microarrays

(71) Applicants: Marc David Porter, Park City, UT (US); Anton Sergeyevich Klimenko, Salt Lake City, UT (US); Aleksander Skuratovsky, Salt Lake City, UT (US); Jennifer Harnisch Granger, Salt Lake City, UT (US)

(72) Inventors: Marc David Porter, Park City, UT (US); Anton Sergeyevich Klimenko, Salt Lake City, UT (US); Aleksander Skuratovsky, Salt Lake City, UT (US); Jennifer Harnisch Granger, Salt Lake City, UT (US)

(73) Assignee: University of Utah, Salt Lake City, UT (US)

(21) Appl. No.: 16/934,102

(22) Filed: Jul. 21, 2020

Related U.S. Application Data
(60) Provisional application No. 62/879,803, filed on Jul. 29, 2019.

(51) Int. Cl. B01L 3/00

(52) U.S. Cl. CPC B01L 3/50857; B01L 2200/16; B01L 2300/12; B01L 2400/086

(57) ABSTRACT

This invention discloses a design of microplates and microarrays to improve utility. The new design constructs a physical flux barrier that limits thermocapillary and other mass transfer contributions to the heterogeneous accumulation of reactant at the surface of a well or array address. The improved control of reactant delivery results in a much more uniform distribution of reactant across an address, thereby improving the accuracy of the measured response.

### REFERENCE TO RELATED APPLICATION

This application claims inventions disclosed in Provisional Patent Application No. 62/879,803, filed Jul. 29, 2019, entitled “SMART WELL PLATE AND ADAPTOR.” The benefit under 35 USC § 119(e) of the above mentioned United States Provisional Applications is hereby claimed, and the aforementioned application is hereby incorporated herein by reference.

### FIELD OF THE INVENTION

This invention relates to microplates, microarrays, and other types of structures that act like small test tubes or microspots on a solid surface, which are used, for example, in the analytical, bioanalytical, and combinatorial sciences.

### BACKGROUND

A microplate, also referred to as a microwell plate or multiwell plate, is composed of a number of wells that act in some manner as small test tubes for homogeneous and heterogeneous reaction processing. The most common microplate designs have 1, 6, 12, 24, 96, 384, and 1536 wells per plate. Wells are usually circular, square, or rectangular in shape. A microplate is therefore viewed as a three-dimensional container, having, in particular, a readily identifiable depth that is defined by the height of the sidewalls of the well. A microarray is a more recent embodiment of a microplate. A microarray can be viewed as a two-dimensional version of a microplate. Microarrays are usually formed by spotting and drying reagents for a given reaction, assay or analysis directly onto a solid substrate (e.g., glass, silicon, plastic, or other relatively inert material) and the test specimen is then placed directly on the dried spot, which is generally referred to as an address. The size of the dried spot, therefore, defines the number of “two-dimensional test tubes” in the microarray. Based on the design differences, a well in a microplate can be constructed to hold a liquid volume that usually ranges from a few milliliters down to a few microliters and sometimes less. The volumes of liquid used in a microarray are at the lower end of the range for a well in a microplate and can be as low as a few picoliters and even less.

While microplates and microarrays have proven invaluable to many areas of research, many of their designs are negatively affected by the formation of heterogeneous patterns (e.g., a “coffee ring”) of reactant and/or product across the surface of a well in a microplate or spot in a microarray. The heterogeneity of accumulation has a negative impact on the accuracy and precision of the collected data. The origin of the heterogeneity in the accumulation of reactant and/or product is linked, at least in part, to the thermocapillary mass convection of materials that occurs at the air-liquid interface of an evaporating sessile drop. It is therefore evident that approaches that can reduce, if not eliminate, the heterogeneity in these accumulation patterns would improve the utility of microplates and microarrays.

In the following sections, the areas in the wells of a microplate and the spots in a microarray at which the accumulated reactant and/or product are measured will be collectively referred to as addresses.

### SUMMARY OF THE INVENTION

The goal of the present invention is to overcome the heterogeneity in the accumulation of a measured species across each address in a microplate or microarray, thereby greatly improving the use of these types of platforms in a wide range of tests, including immunoassays and hybridization assays. The new design constructs a physical barrier that limits thermocapillary and other mass transfer contributions to the heterogeneous accumulation of reactant and/or product at the surface of a well or array address. This capability is demonstrated by using a sandwich immunoassay for human immunoglobulin G protein (h-IgG).

### BRIEF DESCRIPTION OF THE FIGURES

The accompanying figures, when coupled together with the detailed descriptions presented below, serve to illustrate further various embodiments of the invention and to explain various principles and advantages associated with the present invention.

FIG. 1 is an example of a “coffee ring” formed by radial-based diffusional delivery of reactants and/or products to an address. This experimental result is for a sandwich immunoassay for human immunoglobulin G (IgG) at a concentration of 10 ng/mL when captured on a surface modified with a coating of anti-human IgG antibody as measured using Raman spectroscopy and gold nanoparticle labels. It shows a higher analyte surface density (ρₛ) around the edges (darker regions) of the address and a lower analyte surface density closer to the center of the address (lighter regions). While this example is for an immunoassay, “coffee rings” and other types of heterogeneity in accumulation are also found in DNA hybridization assays and other types of assays.

FIG. 2A is an exemplary illustration of a droplet on the address of a conventional microarray (left) and a conventional microplate with an address smaller in size than the bottom of the well (right).

FIG. 2B depicts the diffusional delivery of reactant to an address that, as shown in FIG. 2A, results in the formation of a “coffee ring.” The different weightings of the arrows (thicker is higher) denote the difference in the flux of reactant and/or product to the capture surface. That is, the contribution to reactant and/or product flux at the surface of an address with larger, bolder arrows indicates a higher flux near the periphery of the address, and smaller, lighter arrows indicate a lower flux near the center of the address. This is an example of how the design of a well or address can result in heterogeneity in the accumulation of reactant and/or product across an address;

FIG. 3A is an exemplary illustration of a droplet on the address of a smart microarray (left) and a smart microplate well (right) that have a flux barrier used to control the flux of reactant and/or product accumulated on the address.

FIG. 3B depicts the diffusional delivery of reactant to an address as shown in FIG. 3A, which has flux barriers that mitigate the heterogeneous accumulation of reactant across the address. The uniformity of the size of the arrows denotes how the barrier results in a more uniform flux of reactant to the surface. This is an example of how a flux barrier can improve the uniformity of the accumulation of reactant and/or product across an address;

FIG. 4 shows the steps and components of a sandwich immunoassay that uses surface-enhanced Raman scattering for readout, capture of the target analyte by an antibody-modified surface, labeling the captured analyte with modified gold nanoparticles, and signal readout with Raman spectrometer;

FIG. 5 presents grayscale maps showing simulated solution phase Ag distributions for a circular address with a radius of 1000 μm in a well with a radius of 2000 where inset A of FIG. 5 is the distribution for a conventional well without flux barrier and inset B of FIG. 5 is the distribution for a smart well with flux barrier. Inset C and inset D of FIG. 5 are the experimentally determined surface density (ρₛ) maps from the Raman scattering measurements of accumulation at the 1000 μm circular addresses for the conventional well (inset C of FIG. 5) and the smart well (inset D of FIG. 5). Inset A and inset C of FIG. 5 are, therefore, examples of the distribution in accumulation for the flux profile shown in FIG. 2B, whereas inset B and inset D of FIG. 5 are examples of the distribution in accumulation for the flux profile shown in FIG. 3B, i.e., a Smart Microplate and a Smart Microarray. The darker shading represents regions of higher signal density and the lighter shading represents regions of lower signal density;

FIG. 6 presents the modeled surface densities for the gold nanoparticle labels, which are referred to as extrinsic Raman labels (ERLs), for a 1000 μm circular addresses in a 2000 μm circular well with flux barriers positioned at different distances (d) from the edge of the address. The computed surface densities for the ERLs are for an immunoassay for a liquid sample spiked at 1 ng/mL of h-IgG. The x-axis relates to the position of the measurement from the center of the address. The y-axis corresponds to the number of ERLs that are bound per square micron. The different plots correspond to how close the flux barrier is to the perimeter of a 1000 μm (radius) address. The 1000 μm curve is for reference purposes and corresponds to the case in which there is no flux barrier (see FIG. 2). The 0 μm curve corresponds to the flux controlled by the Smart Microarray and Microplate architecture shown in FIG. 3;

FIG. 7 presents the modeled ERL surface densities for wells with flux barriers structured at different angles (θ) from the surface of the address. The computed surface densities for the ERLs are for an immunoassay for a liquid sample spiked at 1 ng/mL of h-IgG. The x-axis relates to the position of the measurement from the center of the address. The y-axis corresponds to the number of ERLs that are bound per square micron. The different plots correspond to different configurations of the flux barrier as a function of the offset angle θ. The 90° curve corresponds to the case in which the flux is controlled by the Smart Microarray and Microplate architecture, as exemplified in the 0 μm curve in FIG. 6;

FIG. 8 presents the modeled ERL surface density for flux barriers with different heights (h), which are used to control the flux for a circular address with a radius of 1000 μm. The computed surface densities for the ERLs are for an immunoassay for a liquid sample spiked at 1 ng/mL of h-IgG. The x-axis relates to the position of the measurement from the center of the address. The y-axis corresponds to the number of ERLs that are bound per square micron. The different plots correspond to flux barriers of different heights. The 0 mm curve is for reference purposes and corresponds to the case in which the flux of reactant and/or product are not restricted by a flux barrier (see insets A&C of FIG. 5); and

FIG. 9 presents experimentally measured ERL surface density for flux barriers with heights of 0.0 mm (circles), 0.5 mm (crosses), and 1.0 mm (diamonds) for an immunoassay for a liquid sample spiked at 1 ng/mL of h-IgG. The predicted ERL surface density, from FIG. 8, for the same flux barrier height, is shown in solid black lines. The inset is a top-view SEM image of ERLs on the surface of the address and serves as an example of the images used to correlate ERL density to SERS signal.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

By way of context, the embodiments of the present invention are described within the framework of a heterogeneous immunoassay. It should, however, be readily recognized to those skilled in the art that these embodiments apply well beyond this illustrative example to include the use of microplates and microarrays in all areas of investigative science and technology.

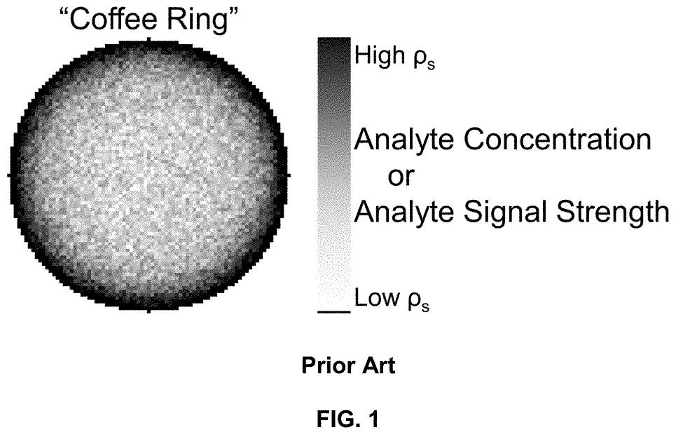

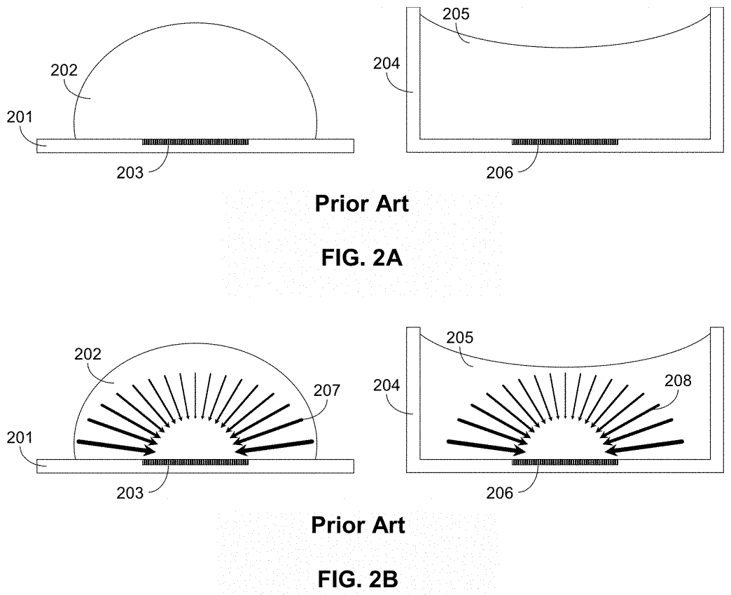

Micro- and nano-assay-based biosensing platforms are increasingly important for clinical screening and diagnostic devices. One of the most common types of microassays is surface capture assays, which employ antibodies, oligonucleotides, carbohydrates, and other forms of molecular recognition elements that are immobilized onto a surface in order to bind selectively a target disease marker or other type of analyte. Methods, such as fluorescence, Surface Enhanced Raman Spectroscopy (SERS), electrochemistry, ultraviolet-visible spectroscopy, and quartz crystal microbalances (QCMs), are frequently used to measure directly or indirectly the accumulated analyte. However, the formation of heterogeneous accumulation patterns of the analyte across the capture address degrades the accuracy of the measured response. The most common heterogeneous distribution pattern is the coffee ring pattern depicted in FIG. 1. In this case, the analyte concentration is much higher at the edges of a circular address than in the center of the address. The origin of these patterns arises, at least in part, from the thermocapillary mass convection of materials that occurs at the air-liquid interface of an evaporating sessile drop and from the larger flux of analyte at the edge of an address compared to the flux at locations closer to the center of the address. This is further illustrated in FIGS. 2A&B, which depicts the diffusional delivery of reactant and/or product to an address that results in the formation of a “coffee ring.” The left of FIG. 2A shows a liquid droplet sample 202 deposited on the address 203 on the substrate 201 of a conventional microarray. The right of FIG. 2A shows a liquid droplet sample 205 deposited on the address 206 in the well 204 of a conventional microplate. FIG. 2B depicts the diffusional delivery of reactant to the addresses, as shown in FIG. 2A, where the arrows 207 and 208 denote the flux of reactant and/or product to the address 203 and 206, respectively. The different weightings of the arrows (thicker is higher) denote the difference in the flux of analyte to the capture surface. That is, the contribution to reactant and/or product flux at the surface of an address with larger, bolder arrows indicating a higher flux near the periphery of the address, and smaller, lighter arrows indicating a lower flux near the center of the address. This is an example of how the design of a well or address can result in heterogeneity in the accumulation of reactants and/or product across an address.

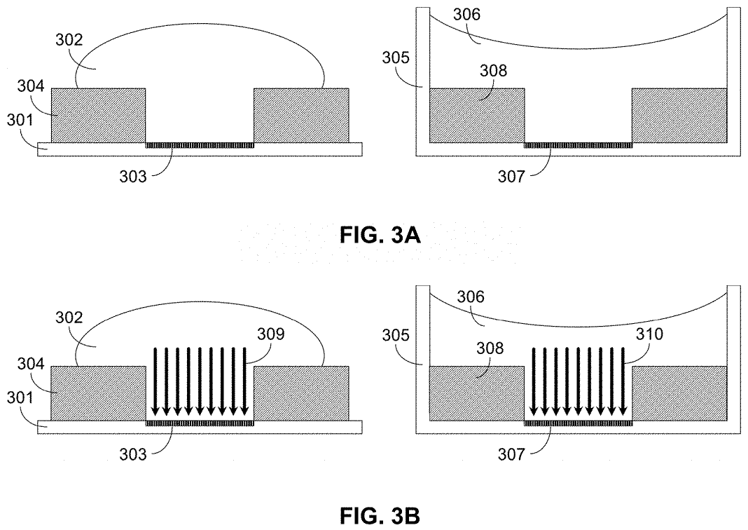

This invention overcomes these and related obstacles that have a negative impact on the utility to microplates and microarrays by redesigning the structure of a well in order to redefine the delivery and the formation of a more homogeneous accumulation of reactant and/or product across the surface of the address. FIG. 3A shows an example of how the structure of an address can be changed in order to physically limit the flux of reactant and/or product primarily to only the analyte in the liquid directly above the address and not from the liquid beyond the edges of the address, where FIG. 3A (left) shows the address design for a smart microarray and FIG. 3A (right) shows the address design for a smart microplate. While there are a number of approaches to reach this condition, FIG. 3A creates this condition by placing a structural insert around the address that acts as a flux barrier to the reactant and/or product. In FIG. 3A (left), the flux barrier 304 is placed on top of the substrate 301 of the microarray with its sidewall adjacent to the address 303. In FIG. 3A (right), the flux barrier 308 is placed on the bottom of the well 305 of the microplate in a position between the address 307 and the sidewall of the well 305. In FIG. 3A, the flux barrier 304 and 308 physically limits the delivery of reactant and/or product from the liquid droplet 302 and 306 to that directly above the active surface of the address 303 and 307, which reduces the heterogeneity in the accumulation of reactant and/or product across the surface of the address. The overall benefit of this design is that it creates a more uniform distribution of the analyte on the surface of the address by creating a more uniform flux of reactant to the surface. FIG. 3B depicts the diffusional delivery of reactant to the address as shown in FIG. 3A, where the arrows 309 and 310 denote the flux of reactant and/or product to the address 303 and 307, respectively. The flux barriers 304 and 308 mitigate the heterogeneous accumulation of reactants and/or products across the address. The uniformity of the size of the arrows 309 and 310 denotes how the design of the well results in a more uniform flux of reactant and/or product to the surface. This is an example of how the design of a well or address can improve the uniformity of the accumulation of reactants and/or product across an address. These flux barriers and address structures can be fabricated in any number of ways including photolithography, micromachining, electrochemical deposition, template stripping, spin coating, and vapor deposition using materials typically employed as vessels for chemical and biochemical reactions and analyses, such as natural and human-made biomaterials, wood, paper, textiles (natural/synthetic), leather, glass, crystalline materials, biocomposite materials (bone/conch shell), plastics (natural/synthetic), rubber, (natural/synthetic), carbon, graphite, graphene, and diamond materials, wax (natural/synthetic), metals, minerals, stone, concrete, plaster, ceramics, foams, salts, metal-organic frameworks (MOFs), covalent organic frameworks (COFs), nanomaterials, metamaterials, semiconductors, insulators, and composites of all of these.

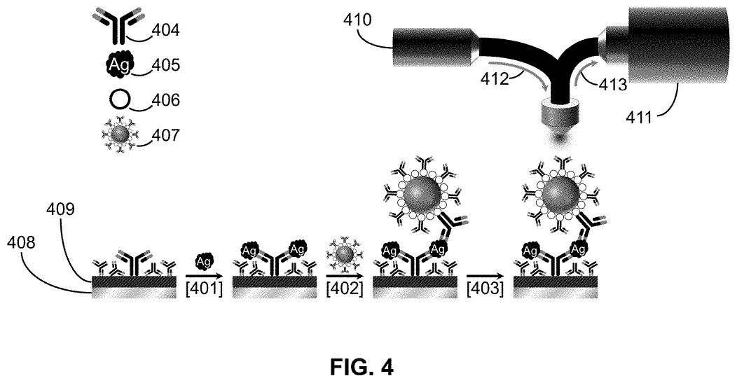

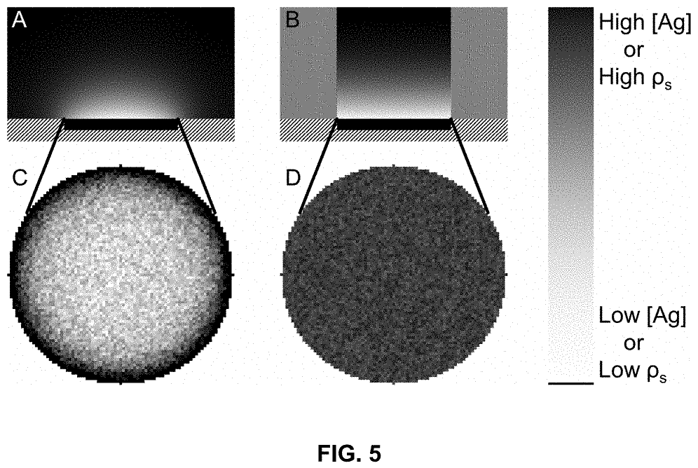

The utility of this approach in mitigating “coffee ring” formation is demonstrated by the data presented in FIGS. 5 through 9, which uses a heterogeneous immunoassay based on surface-enhanced Raman scattering (SERS) as an optical readout. This approach is illustrated in FIG. 4, which shows the steps and components of a sandwich immunoassay that uses surface-enhanced Raman scattering for readout, including capture of the target analyte by an antibody-modified surface (401), labeling the captured analyte with modified gold nanoparticles (402), and signal readout with Raman spectrometer (403). It employs an antibody (Ab) 404 coated on gold, silver, or other surfaces 409 to form a capture substrate and a label 407 to tag the captured antigen (Ag) 405. The label 407 usually consists of gold, silver, or other plasmonic material that is typically coated with a Raman-active reporter molecule (RRM) and an antigen-specific layer of Abs. The spectral features of the RRM on the nanoparticle label are then used to identify the presence of an Ag, and the strength of the signal is used to quantify the amount of Ag present in the sample by means of a calibration plot. This illustrative example has the antibody-modified capture surface being composed of two components: a thin film of gold or other material (409) that has been formed on a more structurally rigid substrate (408) like glass or silicon. The signal from the sample is measured by using a Raman spectrometer, which, in this case, uses a fiber optic bundle (412) to carry light from a laser excitation source (410) to the sample, with the scattered light collected and carried by another fiber optic bundle (413) to a spectrometer (411).

In this example, capture addresses were defined using either octadecane thiol (ODT) as the ink on polydimethylsiloxane (PDMS) stamp or with paraffin wax sheets with a hole cut in its center using a 2 mm biopsy punch. A finite element model was used to take into account chemical equilibria during the various steps involved in preparing the assay. The computational model was used to predict how the presence of a confining well would affect antigen (Ag) deposition and Extrinsic Raman Label (ERL) deposition.

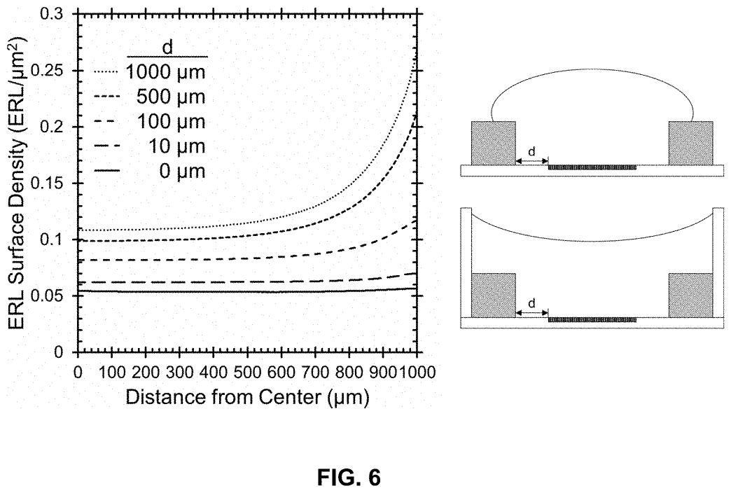

In FIGS. 3A&B, the flux barrier is placed adjacent to the address, i.e., the distance from the edge of the address to the flux barrier is 0. To illustrate how the distance from the edge of the address to the flux barrier will affect the uniformity of the analyte distribution, FIG. 5 shows the predicted solution-phase Ag and ERL distributions when a circular shaped address is confined by flux barriers positioned at different distances from the edge of the address. The addresses, in this case, have a radius of 1000 μm, and the distance from the flux barrier to the address varies from 1000 μm (inset A of FIG. 5) down to 0 μm (inset B of FIG. 5). The differences in Ag distribution for flux barriers at different distances show that the more confining flux barriers (smaller distances) result in a much more homogeneous Ag distribution. The differences in ERL distribution are more difficult to see from the color maps, so for clarity, the ERL surface density is graphed as a function of distance from the address center for all of the different flux barrier positions (FIG. 6). When the flux barrier is positioned far from the address edge (FIG. 6 dotted line), the ERL distribution is found to be very heterogeneous, leading to ring formation. As the distance decreases and the flux barrier gets closer to the address edge (FIG. 6 dashed lines), the ERL distribution becomes more homogeneous. However, even when the flux barrier is just 10 μm away from the address edge, there is heterogeneity in both the Ag distribution and the ERL distribution (FIG. 6 long dashed line). It is not until the flux barrier is adjacent to the address that the Ag distribution (inset B of FIG. 5) and ERL distribution (FIG. 6 solid line) is completely homogeneous. This means that any extra space between the flux barrier and the edge of the address leads to heterogeneous Ag and ERL distributions.

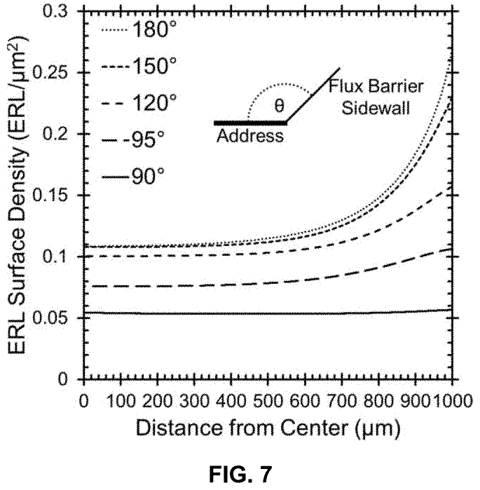

The next set of results show how changing the angle of the sidewall of the flux barrier from the address affected the Ag and ERL deposition (FIG. 7) by examining sidewall angles (θ) ranging from 180°, which is the same as no flux barrier (FIG. 7 dotted line), down to vertical, 90° flux barrier (FIG. 7 solid line). The ERL surface density is graphed as a function of distance from the address center for all of the different configurations. It is clear that the vertical sidewall (inset B of FIG. 5, FIG. 7 solid line) results in the most homogeneous Ag and ERL distributions and that heterogeneity increases with increasing wall angle.

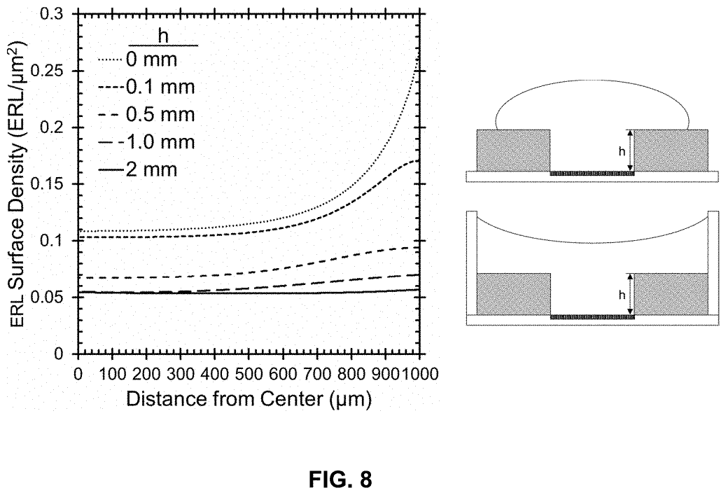

The effect of flux barrier height was also investigated, and the results are presented in FIG. 8. Flux barrier with heights (h) of 0.0 mm, 0.1 mm, 0.5 mm, 1.0 mm and 2.0 mm were modeled. Again, the normalized ERL surface density is shown as a function of distance from the address center (FIG. 8). In the absence of a flux barrier (FIG. 8 dotted line) the distribution of both Ag and ERL is heterogeneous. The addition of a flux barrier 0.1 mm in height (FIG. 8 short, dense dashed line) does little to improve the homogeneity. A flux barrier with a height of 0.5 mm (FIG. 6 short sparse dashed line) significantly reduces the heterogeneity, but not until the height reaches 1.0 mm (FIG. 6 long dashed line) do the Ag, and ERL distributions become homogeneous.

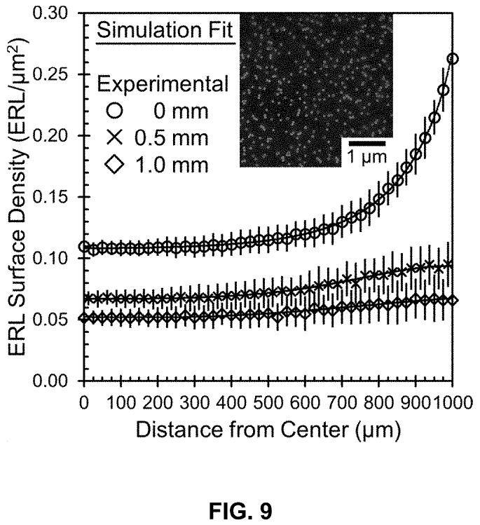

From the results in FIGS. 5-8, it is clear that the most homogeneous distribution of both the Ag and ERL is achieved with a flux barrier with a vertical sidewall and positioned adjacent to the address. The ratio of the height of the flux barrier to the size of the address (i.e., the diameter of the address for a circular shaped address) should preferably be 1:2 or greater. These parameters are used to create experimental assays using paraffin wax sheets to create the flux barriers. In order to measure the homogeneity of the deposition over the address, top-view Scanning Electron Microscope (SEM) images were taken, and the ERL density at various points between the address center and edge was correlated to SERS signal. An example SEM image is shown in FIG. 9 (inset). After the ERL density was correlated to the SERS signal, the SERS signal was then used to measure the ERL density as a function of the address radius. FIG. 9 shows the ERL surface density predicted by the model (solid lines) and experimentally determined (circles, crosses, diamonds) for an address of 1000 μm radius that is surrounded with flux barriers with 90° sidewalls, and various heights. From this data, it is clear that the experimental results agree very well with the prediction. Top view SERS signal map of addresses with 0 mm and 1 mm high flux barriers are shown in insets B&D of FIG. 5. From both these maps and FIG. 9, it is clear that the 1 mm flux barrier results in a homogeneous ERL distribution while the 0 mm flux barrier (i.e., no flux barrier) results in ring formation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims, including any amendments made during the pendency of this application and all equivalents of those claims as issued.

What is claimed is:

1. A microarray having a plurality of addresses for measuring the accumulation of reactants and/or products, each of the plurality of addresses being surrounded by a flux barrier, wherein the flux barrier physically limits the accumulation of the reactants and/or products to above the address and results in a more uniform accumulation of the reactants and/or products over the address.

2. The microarray of claim 1, wherein the flux barrier is positioned adjacent to the address.

3. The microarray of claim 1, wherein the flux barrier is realized by one of the following methods or their combinations: a physical insert that acts to recess and surround the address; photolithographic patterning on top of the address; laser ablation removal of material directly on top of the address; extrusion directly around the address; electrodeposition; and polymeric coatings.

4. The microarray of claim 1, wherein the angle from the sidewall of the flux barrier to the address is 90 degrees.

5. The microarray of claim 1, wherein the ratio of the height of the flux barrier to the size of the address is 1:2 or greater.

6. The microarray of claim 1, is fabricated by materials typically used as vessels for chemical and biochemical reactions and analyses, including but are not limited to: natural and human-made biomaterials, wood, paper, textiles (natural/synthetic), leather, glass, crystalline materials, biocomposite materials (bone/conch shell), plastics (natural/synthetic), rubber, (natural/synthetic), carbon, graphite, graphene, and diamond materials, wax (natural/synthetic), metals, minerals, stone, concrete, plaster, ceramics, foams, salts, metal-organic frameworks (MOFs), covalent organic frameworks (COFs), nanomaterials, metamaterials, semiconductors, insulators, and composites of all of these.

7. A microplate having a plurality of wells for measuring the accumulation of reactants and/or products, each of the plurality of wells comprising:
an address at the bottom of the well for receiving the accumulation of the reactants and/or products; and
a flux barrier between the address and the sidewall of the well, wherein the flux barrier surrounds the address and physically limits the accumulation of the reactants and/or products to above the address and results in a more uniform accumulation of the reactants and/or products over the address.

8. The microplate of claim 7, wherein the flux barrier is positioned adjacent to the address.

9. The microplate of claim 7, wherein the flux barrier is realized by one of the following methods or their combinations: a physical insert that acts to recess and surround the address; photolithographic patterning on top of the address; laser ablation removal of material directly on top of the address; extrusion directly around the address; electrodeposition; and polymeric coatings.

10. The microplate of claim 7, wherein the angle from the sidewall of the flux barrier to the address is 90 degrees.

11. The microplate of claim 7, wherein the ratio of the height of the flux barrier to the size of the address is 1:2 or greater.

12. The microplate of claim 7, is fabricated by materials typically used as vessels for chemical and biochemical reactions and analyses, including but are not limited to: natural and human-made biomaterials, wood, paper, textiles (natural/synthetic), leather, glass, crystalline materials, biocomposite materials (bone/conch shell), plastics (natural/synthetic), rubber, (natural/synthetic), carbon, graphite, graphene, and diamond materials, wax (natural/synthetic), metals, minerals, stone, concrete, plaster, ceramics, foams, salts, metal-organic frameworks (MOFs), covalent organic frameworks (COFs), nanomaterials, metamaterials, semiconductors, insulators, and composites of all of these.
